(19) United States
(12) Patent Application Publication
(10) Pub. No.: US 2013/0191208 A1
(43) Pub. Date: Jul. 25, 2013

(54) ANALYTICAL QUANTIFICATION OF WEB-SITE COMMUNICATIONS ATTRIBUTED TO WEB MARKETING CAMPAIGNS OR PROGRAMS

(71) Applicants: Deepesh Chourey, Dublin, CA (US); Jamie Morales, Tempe, AZ (US)

(72) Inventors: Deepesh Chourey, Dublin, CA (US); Jamie Morales, Tempe, AZ (US)

(73) Assignee: LimeLight Networks, Inc., Tempe, AZ (US)

(21) Appl. No.: 13/356,907

(22) Filed: Jan. 24, 2012

Related U.S. Application Data
(60) Provisional application No. 61/589,654, filed on Jan. 23, 2012.

(51) Int. Cl. G06Q 30/02

(52) U.S. Cl. 705/14.45; 705/14.41

(57) ABSTRACT

A method and system for analyzing marketing campaigns for increasing visitors' interactions with a webpage is disclosed. A plurality of landing pages are created, each being associated with a different marketing campaign. Visitors that access the web site are assigned to a progression level (e.g., “Anonymous”; “Converted”; “Qualified”) based on their interactions with the web site. Specific marketing campaigns are credited with progression-level increases, based on which landing page a visitor accessed prior to a progression-level increase. Values of statistics are generated for multiple marketing campaigns based on the credits. The values of the statistics can be simultaneously presented to a user, such that the user may compare the efficacy of multiple campaigns.

### CROSS-REFERENCES TO RELATED APPLICATIONS

The present application is a non-provisional patent application, claiming the benefit of priority of U.S. Provisional Application No. 61/589,654 filed on Jan. 23, 2012, entitled, “ANALYTICAL QUANTIFICATION OF WEB-SITE COMMUNICATIONS ATTRIBUTED TO WEB MARKETING CAMPAIGNS OR PROGRAMS,” which is hereby incorporated by reference in its entirety.

### BACKGROUND

This disclosure relates in general to an analytical quantification of web-site hits and responsive inputs linked to specific recruitment programs.

Web sites are often an integral plan in advertising products and engaging customers or potential customers. However, customers or potential customers may be unaware of or may have forgotten of the existence of the web sites. A web-site owner may thus choose to use one or a variety of recruitment programs (e.g., marketing campaigns) to encourage customers or potential customers to access the web site.

An effective recruitment program may increase traffic to a web site, increase engagement with the web site (e.g., by increasing inputs received from users in response to web site queries), and increase a customer base. Nevertheless, predicting which recruitment program will be effective in achieving one or more of these effects is a difficult task. Even after a particular program is chosen, it may be difficult to estimate how effective the campaign is in meeting these objectives. For example, increased site traffic may be attributable to a variety of occurrences independent from the campaign, such as increased links from other web sites or improved search rankings.

### SUMMARY

In one embodiment, the present disclosure provides a method and system for quantitatively assessing recruitment programs' results. Each of a plurality of landing pages of a web site is associated with a particular recruitment program (e.g., one implemented during a specific time period, using a specific strategy, using a third-party product or service, etc.). Thus, when a visitor accesses the particular landing page, the access may be attributed to the particular associated recruitment program (e.g., by identifying a recruitment program associated with a uniform resource locator of the landing page in a look-up table). The visitor is associated with a particular visitor profile (e.g., a default anonymous profile or a visitor-particular profile identified using cookies). The visitor's communications with the site (e.g., access to the web site, time spent at the web site, information entered in response to queries, etc.) is tracked and assessed, and the visitor's profile is updated to identify a level of engagement. Any advancement in levels of engagement is attributed to the recruitment program associated with the landing page most recently accessed by the visitor prior to the advancement. Thus, a web-site owner may quantitatively estimate whether, and to what degree, a recruitment program increased a number of visitors viewing its web site and/or increased visitors' engagement with the web site. Common-scale analysis may further allow the owner to compare effects across multiple recruitment program.

In some embodiments, a program-analysis system for quantitatively estimating increases in web-site communications attributed to various recruitment programs is provided. The program-analysis system includes: a plurality of landing pages, each landing page of the plurality of landing pages comprising a unique landing-page uniform resource locator (URL), and each landing page of the plurality of landing pages being associated with the web site; a landing-page database storing associations between each of the plurality of landing pages with a recruitment program; a visitor-profile database storing a visitor profile for each of a plurality of visitors, each visitor profile comprising historical-interaction information characterizing any previous interaction between the visitor and the web site; an interaction-assessment engine configured to, for each visitor of a plurality of visitors that accesses each landing page of the plurality of landing pages: detect the visitor's access to a landing page; identify a recruitment program associated with the landing page based on an analysis of a URL of the landing page; associate the visitor with a visitor profile stored in the visitor-profile database; track the visitor's interaction with the web site subsequent to the visitor's access to the landing page; determine recent-interaction information characterizing the visitor's interaction with the web site subsequent to the visitor's access to the landing page; identify a change between the historical-interaction information and the recent-interaction information in the profile; and attribute the recruitment program associated with the landing page with the change between the historical-interaction information and the recent-interaction information in the profile; and a statistics generator configured to generate or update a value of at least one statistical variable associated with the recruitment program, the value of the at least one statistical variable being related to an efficacy of the recruitment program at increasing visitors' c with the web site, and the generation or updating being based on any changes between the historical-interaction information and the recent-interaction information attributed to the recruitment program. The campaign-analysis system may further include: a progression design comprising a plurality of progression levels, the plurality of progression levels comprising a first progression level and a second progression level, wherein the change between the historical-interaction information and the recent-interaction information in the profile that is identified by the interaction-assessment engine comprises a change from the first progression level to the second progression level. The statistics generator may be further configured to generate a report presenting the value of the at least one statistical variable associated with the recruitment program and presenting a second value of the at least one statistical variable associated with a second recruitment program. The statistics generator may be further configured to: receive input comprising an analysis time frame; and generate or update the value of the at least one statistical variable based on any changes between visitors' historical interaction information and visitors' recent interaction information attributed to the recruitment program, the changes occurring within the analysis time frame. The at least one statistical variable may include a number of visitors that accessed a landing page associated with the recruitment program. The at least one statistical variable may include a number of visitors that interacted with the web site subsequent to the visitors' access to the landing page, the interaction comprising entering identifying information via the web site. The interaction-assessment engine may be further configured to, for each visitor of the plurality of visitors that accesses each landing page of the plurality of landing pages: determine whether the visitor can be partly or completely identified, wherein the visitor is associated with a default visitor profile stored in the visitor-profile database upon a determination that the visitor cannot be partly or completely identified.

In some embodiments, a method for quantitatively estimating increases in web-site communications attributed to various recruitment programs is provided. The method may include: creating a plurality of landing pages for a web site; associating each of the plurality of landing pages with a recruitment program of a plurality of recruitment programs; monitoring visitors' access to each of the plurality of landing pages; upon detecting a visitor accessing a landing page of the plurality of landing pages: identifying a recruitment program of the plurality of recruitment programs associated with the landing page; and tracking the visitor's communications with the web site subsequent to the visitor's access to the landing page; receiving input from a user, the input identifying a recruitment program of the plurality of recruitment programs; generating a value of a statistical variable, the value of the statistical variable being related to an efficacy of the recruitment program identified by the input at increasing visitors' communications with the web site; and presenting value of the statistical variable to the user. The method may further include, upon the detecting the visitor accessing the landing page of the plurality of landing pages: associating the visitor with a visitor profile. The method may further include, upon the detecting the visitor accessing the landing page of the plurality of landing pages: updating, based on the visitor's communications with the web site subsequent to the visitor's access to the landing page, a progression level associated with the visitor. The value of the statistical variable may identify a number of visitors that increased progression levels. The method may further include: receiving second input from a user, the second input identifying a second recruitment program of the plurality of recruitment programs; generating a second value of the statistical variable, the second value being related to an efficacy of the second recruitment program identified by the second input at increasing visitors' communications with the web site; and presenting the second value of the statistical variable to the user, wherein the value and second value of the statistical variable are presented to the user simultaneously. The value and the second value of the statistical variable may be presented graphically to the user. The value of the statistical variable may identify a number of visitors that accessed a landing page, the landing page being associated with the recruitment program identified by the input.

In some embodiments, one or more machine-readable medium having machine-executable instructions configured to quantitatively estimate increases in web-site communications attributed to various recruitment programs is provided. The one or more machine-readable medium may include code for: creating a plurality of landing pages for a web site; associating each of the plurality of landing pages with a recruitment program of a plurality of recruitment programs; monitoring visitors' access to each of the plurality of landing pages; upon detecting a visitor accessing a landing page of the plurality of landing pages: identifying a recruitment program of the plurality of recruitment programs associated with the landing page; and tracking the visitor's communications with the web site subsequent to the visitor's access to the landing page; receiving input from a user, the input identifying a recruitment program of the plurality of recruitment programs; generating a value of a statistical variable, the value being related to an efficacy of the recruitment program identified by the input at increasing visitors' communications with the web site; and presenting the value of the statistical variable to the user. The statistical variable may identify a number of visitors that increased progression levels. The statistical variable may identify a number of visitors that accessed a landing page associated with the recruitment program identified by the input. The value of the statistical variable may be presented graphically in a report. The one or more machine-readable medium may further include code for: receiving second input from a user, the second input identifying a second recruitment program of the plurality of recruitment programs; generating a second value of the statistical variable, the second value being related to an efficacy of the second recruitment program identified by the second input at increasing visitors' communications with the web site; and presenting the second value of the statistical variable to the user, wherein the value and the second value of the statistical variable are presented to the user simultaneously. The one or more machine-readable medium may further include code for: receiving time-frame input from a user identifying a time frame, wherein the value of the statistical variable is related to an efficacy of the recruitment program identified by the input at increasing visitors' communications with the web site during the identified time frame.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 depicts a block diagram of an embodiment of a campaign-analysis system that analyzes marketing campaigns executed by a campaign-execution system;

FIG. 2 depicts a block diagram of an embodiment of an interaction-assessment engine;

FIGS. 3A and 3B depict a level diagram of embodiments of a progression level design;

FIGS. 4A and 4B illustrate reports presenting information about an estimated effect of marketing campaigns;

FIG. 5 illustrates a flowchart of an embodiment of a process for analyzing marketing campaigns;

FIG. 6 illustrates a flowchart of an embodiment of a process for analyzing visitors' interactions with a web site;

FIG. 7 illustrates a flowchart of an embodiment of a process for generating campaign statistics;

FIG. 8 depicts a block diagram of an embodiment of a computer system; and

FIG. 9 depicts a block diagram of an embodiment of a special-purpose computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

In the appended figures, similar components and/or features may have the same reference label. Where the reference label is used in the specification, the description is applicable to any one of the similar components having the same reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

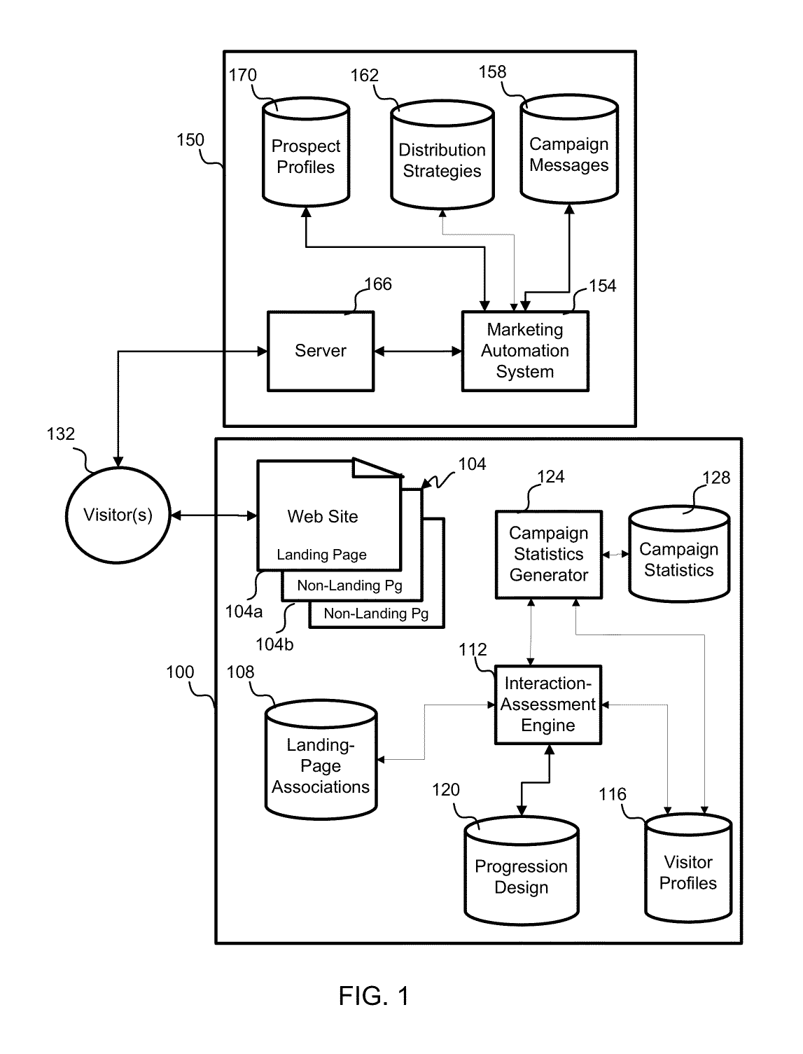

Referring first to FIG. 1, a block diagram of an embodiment of a campaign-analysis system 100 is shown. Visitors 132 interact with a web site 104 of a customer of the campaign-analysis system 100. The web site 104 may include one or more landing pages 104a. Each landing page 104a may, e.g., serve as an entry to other non-landing pages 104b on the web site 104. Landing pages 104a and/or non-landing pages 104b may include a uniform resource locator (URL). Thus, for example, a third-party webpage or html email may include a link to a specific landing page 104a via the landing page's URL.

A landing-page association 108 associates a landing page 104a with one or more marketing campaigns. Another landing-page association 108 may associate another landing page with one or more different marketing campaigns. A landing-page association 108 may include, e.g., a portion of a look-up table (e.g., the association 108 comprising a row, column or identifier shared by a landing page and associated marketing campaign(s)), a portion of a landing page's URL (e.g., identifying an associated marketing campaign), a portion of a database (e.g., associating a marketing campaign with a URL of a landing page or with part of a URL of a landing page), etc.

A marketing campaign is managed and/or executed by a campaign-execution system 150. The campaign-execution system 150 may be external to and/or independent from the campaign-analysis system 100. Campaign-execution system 150 may be, e.g., operated or managed by an entity different from one or more entities operating or managing the campaign-analysis system 100.

The campaign-execution system 150 includes a marketing automation system 154 that drives prospects to the web site 104. The marketing automation system 150 may, e.g., perform e-mail campaigns, online advertising campaigns, social-networking campaigns, etc. to encourage prospects to view and interact with web site 104. Campaign messages 158 are distributed to prospects according to distribution strategies 162 through the server 166 (e.g., an e-mail server or a network server that, e.g., couples the marketing automation system 154 to a third-party web page). For example, a link-embedded campaign message may be e-mailed to prospects, posted to social-networking sites, provided as an advertisement to be published on a third-party web site, etc. A set of prospect profiles 170 may identify information about prospects, such as an e-mail address, name, employer, employment position, interests, previous engagement with the web site 104, etc. Thus, for example, a particular campaign message 158 may be customized for and/or distributed to a particular prospect or a group of prospects. Prospects viewing the campaign message 158 may click-through the message to a landing page 104a on the web site 104. When a prospect becomes a visitor at the web site, the prospect profile 170 associated with the prospect can optionally be provided to the interaction-assessment engine 112 in some embodiments.

Distribution strategies may include strategies regarding, e.g., a time (e.g., of day, or a week, of a month, a month, a season, etc.) to execute the campaign; a group of prospects (e.g., associated with a group of prospect profiles 170) to send the campaign to; an incentive associated with the campaign (e.g., a discount, free offering, etc.); a particular campaign message (from campaign messages 158) or type of campaign message to use in the campaign; a type of communication (e.g., an e-mail message sent to prospects versus an advertisement to be placed on a third party's web site), etc. For example, one distribution strategy may include sending link-embedded email messages to a group of prospects at 2 AM EST on Wednesdays in January to update the prospects on new information on the site, and another distribution strategy may include using Google AdWords™ such that a short site summary may be presented to prospects searching for particular key words on Google™.

A marketing campaign executed by campaign-execution system 150 may persuade a prospect to visit web site 104, thereby becoming a visitor 132 of the web site 104. Specifically, a prospect may click on an embedded link in a campaign message 158, linking the prospect to a landing page 104a on the web site 104, the landing page 104a being associated with the campaign having provided the prospect with the campaign message 158.

The landing page 104a may be specific to a particular type of campaign or a group of types campaigns. For example, a first landing page may be associated with an e-mail campaign updating prospects on new web site information, a second landing page may be associated with an e-mail campaign offering prospects a discount on products or services offered at the web site, and a third landing page may be associated with a Google AdWords™ campaign. The landing page 104a may be specific to a time period. For example, a first landing page may be associated with campaign messages distributed in January, and a second landing page may be associated with campaign messages distributed in February. The landing page 104a may be specific to a prospect or prospect characteristic. For example, a first landing page may be associated with a campaign message e-mailed to Joe Smith, a second landing page may be associated with campaign messages e-mailed to all prospects estimated to be under 30 years old, and a third landing page may be associated with all prospects identified as being CEOs. The landing page 104a may be specific to a marketing-campaign company. For example, an owner of a web site 104 may pay Company A and Company B to execute marketing campaigns to increase traffic to and interaction with the web site 104. Each of Company A and Company B may be associated with its own campaign-execution system 150. A first landing page may be associated with a marketing campaign executed by Company A, and a second landing page may be associated with a marketing campaign executed by Company B.

The campaign-analysis system 100 includes an interaction-assessment engine 112. The interaction-assessment engine 112 could be hosted on the same computer system, hosting service or content delivery network (CDN) as the web site 104. The interaction-assessment engine 112 may detect, record and/or analyze visitors' behaviors. The interaction-assessment engine 112 may detect a visitor's access to a landing page 104a. The interaction-assessment engine 112 may identify a marketing campaign associated with the accessed landing page 104a. The associated marketing campaign may be identified using a landing-page association 108. For example, a landing-page association may include a row of a look-up table shared by the landing-page URL and an associated marketing campaign. As another example, a landing-page association may include a portion of the landing-page URL that itself identifies an associated marketing campaign.

At the time of the detection, the interaction-assessment engine 112 may or may not be able to completely or partly identify the visitor. Complete identification of a visitor may include associating the visitor with a unique visitor profile, with a unique prospect profile, with a unique real-world identity, etc. Partial identification may include associating the visitor with a semi-generic visitor profile or prospect profile (e.g., indicating that the visitor is under 30 years old).

A visitor may be completely or partly identified, e.g., based on a visitors' cookies. For example, if a visitor previously visited the web site 104, a server hosting the web site 104 may have sent a cookie back to the visitor's web browser during the previous visit, the cookie being unique to the visitor. The server may store the cookie, e.g., in a visitor profile 116. Upon a return visit (e.g., while accessing the landing page 104a), the visitor's web browser may send the cookie to the server hosting the landing page 104a (and web site 104) when the landing page 104a is requested. The server hosting the web site 104 may then identify the visitor (e.g., via identifying a visitor profile 116 associated with the visitor) based on the cookie.

A visitor may be fully or partly identified, e.g., based on an analysis of a landing site's URL. For example, a first marketing campaign may be associated with a first landing page and a second marketing campaign may be associated with a second landing page. If the campaigns were distributed to groups of different demographics, demographic information about visitors may be estimated based on which landing page was accessed. If the first campaign was distributed to Person A and the second campaign to Person B, it may be estimated that a visitor accessing the second landing site is Person B.

The visitor 132 may be associated with a visitor profile 116. In some instances, the visitor is associated with a visitor profile 116 only if the visitor 132 is completely or partly identified. In some instances, the visitor is associated with a visitor profile 116 regardless as to whether or not the visitor 132 is completely or partly identified. If the visitor is not partly or fully identified, the visitor may be associated with a default visitor profile 116. Some or all of the default profile's fields may be blank (e.g., “Name”; “email”; etc.). Some or all of the default profile's fields may be predicted (e.g., age group: 30-40 years old; gender: male; etc.). The predictions may be based on a predicted demographic of visitors 132 and/or may include mean, median or mode information entered by of inferred about other visitors 132.

A visitor profile 116 may include profile-identifying information that is used (e.g., by interaction-assessment engine 112) to associate the visitor 132 with the profile 116. Profile-identifying information may include, e.g., a cookie-associated number, a visitor name, an e-mail address, a login name, etc. The profile-identifying information may be unique across profiles, such that, e.g., no more than one profile will be associated with a specific login name. A visitor profile 116 may include personal and/or demographic information, such as the visitor's age, residence address, citizenship, gender, education level, employment status, occupational position, employer, salary, professional buying authority, etc. A visitor profile 116 may include preferences, such as specific services or products of interest, types of services or products of interest, types of content of interest, web-site-presentation preferences (e.g., font sizes, frequency of input requests from the web site), contact-frequency preferences (e.g., to receive no more than one email per month from the web site), etc.

A visitor profile 116 may include web-site-related information. The web-site-related information may include, e.g.: a number of times that the visitor 132 visited the web site 104; dates and times of visits to the web site 104; durations of visits to the web site 104; responsiveness to queries presented by the web site 104 to the visitor 132 (e.g., whether the visitor answered “Please list your employer.”); etc.

A visitor profile 116 may include interaction-related information. Interaction-related information may include a progression level. Visitors are moved between levels that are defined in a progression design 120. The progression designs are stored for multiple web sites 104. A particular web site 104 has a progression level design stored as a progression design that includes multiple levels that visitors can achieve. A web site 104 may include gated content, which is only available conditionally in a particular level of the progression level design or under other predetermined circumstances.

Interaction-related information tracked by interaction-assessment engine 112 and/or stored in a visitor profile 116 may further include a history of progression levels (including past progression levels, dates and times of progress-level transitions, etc.); specific events leading to changes in progression levels; total time spent visiting the web site 104; one or more per-visit times spent visiting the web site 104; responsiveness the web-site-presented queries; frequency of selections of specific options (e.g., links) on the web site 104. Interaction-related information may be, e.g., of a type suggesting whether a visitor is: responsive to a marketing campaign, interested in the web site, interested in a product or service offered by a company associated with the web site, authorized to purchase a product or service offered by a company associated with the web site, willing to provide information (e.g., demographic, personal or employment information) about himself, etc.

Information (e.g., demographic, personal or employment information) in a visitor's profile may be, e.g., identified (based on, e.g., monitoring and analyzing a visitor's interactions with the web site 104) by interaction-assessment engine 112 and/or provided by external sources, such as the campaign-execution system 150. For example, the campaign-execution system 150 may provide the campaign-analysis system 100 with prospect profiles 170 and/or information in prospect profiles 170. A visitor 132 may be identified as a particular prospect (associated with a particular profile and/or information) based on a landing page 104a that he accessed and/or input of limited information identifying himself (e.g., an e-mail address). A visitor profile 116 of the visitor 132 may then be populated using, e.g., a prospect profile 170. In some embodiments, the web site 104 offers different content to different visitors. For example, the web site 104 may provide some information to all visitors, but other gated content only to visitors who have reached a particular qualified level.

Information monitored and/or recorded by the interaction-assessment engine 112 and/or stored in a visitor profile 116 may include: a visitor identifier, an identifier of a domain of the web site 104, an identifier of an accessed landing site 104a, start and stop times of access to the web site 104, a total number of visits to the web site 104, a time of a first visit to the web site 104, a time of a most recent visit to the web site 104, a profile level, one or more interests of the visitor 132, an average duration of a visit to the web site 104, a total number of pages viewed on the web site 104, an average number of pages viewed on the web site 104 per visit, a referring web site's URL, a total number of searches performed on the web site 104, search terms input on the web site 104, total content gates served, total content gates accepted, adjustments to a lead score, one or more content items viewed on the web site 104, one or more media items viewed on the web site 104, visitor actions, a list of identifiers or names of marketing campaigns associated with the profile 118 (e.g., associated with landing pages accessed by the visitor 132), and/or subsequent web-site interaction times attributed to a marketing campaign.

The campaign-analysis system 100 includes a campaign-statistics generator 124, which generates and/or updates campaign statistics 128 which characterize a performance and/or success of a marketing campaign. The campaign statistics 128 may include an estimate as to whether one or more specific marketing campaigns were successful at, e.g.: increasing traffic to and/or interaction with the web site 104. As described above, the interaction-assessment engine 112 may identify a marketing campaign associated with a landing page 104a accessed by a visitor 132 and may further monitor and analyze the visitor's interaction with the web site 104. Using this information (e.g., which may be received directly from the interaction-assessment engine 112 or from information in the visitor's profile 116), the campaign-statistics generator 124 may attribute the visitor's interaction with the web site 112 to the identified marketing campaign. After this attribution, the campaign-statistics generator 124 may update or generate one or more statistics of the identified marketing campaign (e.g., that quantitatively reflect a degree of visitors' access to the landing page 104a and/or interaction with the web site 104).

In one instance, the campaign-statistics generator 124 attributes increases in a visitor's progression level to a marketing campaign. The attributed marketing campaign may be the marketing campaign associated with the landing page 104a that was most recently accessed by the visitor 132 prior to the increase in progression levels. Campaign statistics may be updated to reflect these increases in progression levels. For example, a statistic may reflect: a total number of level increases attributed to a marketing campaign (e.g., counting both each level increase by a particular visitor and level increases by multiple visitors); a total number of visitors having increased their progression level by at least one level; an average per-visitor progress-level increase, etc. Campaign statistics 128 may include time variables, indicating, e.g., a date that a visitor 132 accessed an associated landing page 104a, a date that the visitor 132 increased progression levels, etc.

The campaign-statistics generator 124 may analyze information related to a visitor's historical and/or recent interaction with the web site 104. Campaign statistics 128 may reflect changes between historical and recent interaction attributed to a particular campaign.

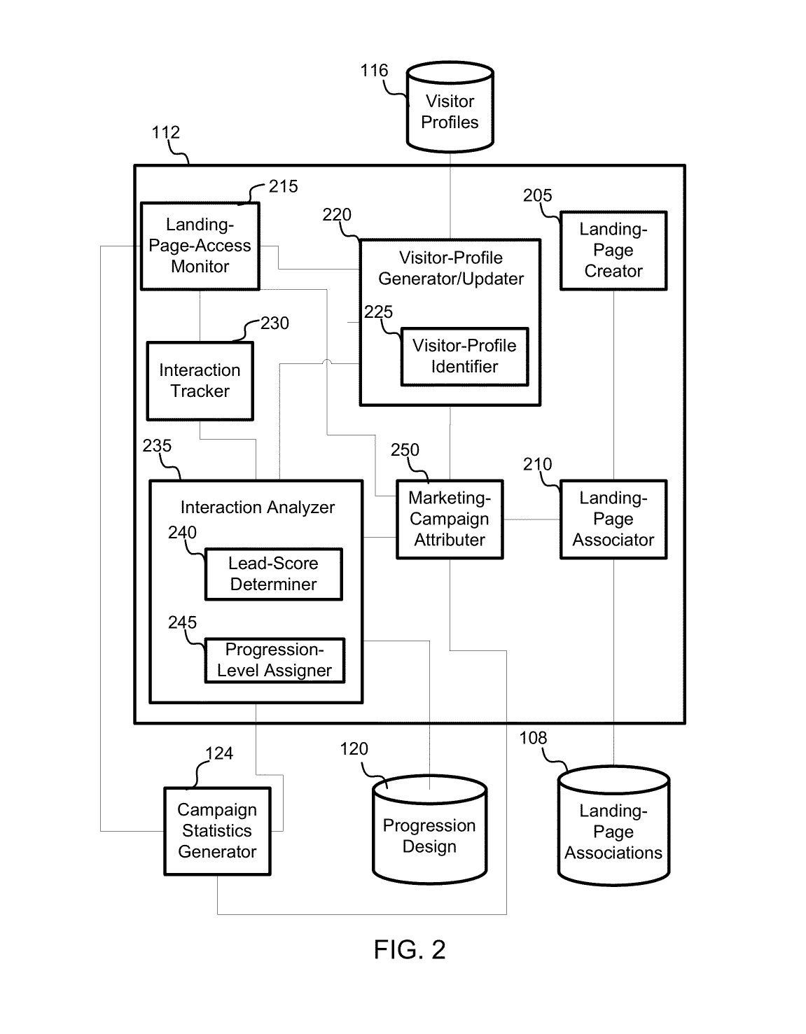

Referring first to FIG. 2, a block diagram of an embodiment of an interaction-assessment engine 112 is shown. Interaction-assessment engine 112 includes a landing-page creator 205. Landing-page creator 205 creates a landing page 104a associated with a web site 104. The landing page may be created, e.g., in response to an input from a customer identifying a marketing campaign to be analyzed. The created landing page may have a unique URL, by which it may be uniquely identified amongst other landing pages. Landing-page associator 210 identifies and stores a landing-page association 108 that associates the created landing page 104a with a marketing campaign. For example, the landing-page associator 210 may add a row or column in a look-up table that identifies the landing-page based on its URL or a part of its URL and identifies the marketing campaign by a unique identifier, description, etc.

The created landing pages 104a are monitored by landing-page access monitor 215. Landing-page access monitor 215 may identify when a visitor 132 accessed any landing page 104a associated with a customer's web site 104. The landing-page access monitor 215 may identify dates and times of visitors' access to particular landing pages. Further, the landing-page access monitor 215 attempts to identify and/or characterize a visitor 132 accessing the landing page 104a. Landing-page access monitor 215 may send, e.g., a cookie received from a visitor device and/or part or all of a URL of an accessed landing page 104a to a visitor-profile generator/updater 220. This information may be used by a visitor-profile identifier 225 of the visitor-profile generator/updater 220 to attempt to identify which (if any) of visitor profiles 116 is associated with a visitor accessing the landing page 104a. For example, a cookie may be stored in visitor profiles and matched to a received cookie. If no profile or no specific profile is identified, the visitor-profile generator/updater 220 may generate a new profile (e.g., using a default profile). The visitor-profile generator/updater 220 may update any existing or new profile to reflect the fact that the landing-page-access monitor 215 detected that the visitor 132 accessed the landing page 104a (and, e.g., a time of access).

Subsequent to detection of a visitor 132 accessing a landing page 104a, the visitor's interactions with the web site 104 is tracked by an interaction tracker 230. The interaction tracker 230 may monitor and record, e.g., a total time that spent on the web site 104, a number of pages viewed, a responsiveness to information queries, a time spent per page on the web site 104, types of identities of links clicked, search queries, etc.

The tracked interactions may be analyzed by an interaction analyzer 235. The interaction analyzer 235 may quantify and/or reduce dimensionalities of the interaction. Specifically, the interaction analyzer 235 includes a lead-score determiner 240 that identifies and/or updates a lead score. The lead score can be a function of the amount of interaction where different actions are given different scores. For example, downloading a white paper, providing additional demographic information, answering questions, viewing video or audio content, reading web pages, browsing time, or other behavioral information is scored to change the lead score. Additionally, the demographic or other information provided to the web site 104 can affect the lead score. For example, a purchasing manager title given may be scored higher than the title of janitor. In some instances, inputs from a customer are used to determine factors that most heavily contribute to high lead scores.

Each visitor 138 may be assigned to a progression level by progression-level assigner 245. The progression-level assigner 245 may be coupled to the progression design 120, which identifies multiple levels that a visitor can achieve. Inputs from the customer may be used to determine the levels and/or level criteria. Assignment to a level may be based, e.g., on a lead score determined by the lead-score determiner 240. For example, a visitor may be promoted one or more levels depending on whether his lead score exceeded a threshold. A visitor's profile 116 may be updated by visitor-profile generator/updater 220 to reflect the determined lead score and/or assigned progression level. In some instances, the profile 116 is only updated if the lead score and/or if the progression level is different from a previous lead scores and/or progression level reflected in the profile.

Interactions with the web site 104 (analyzed by the interaction analyzer 235) and/or accesses to the web site 104 via the landing page 104a (detected by the landing-page-access monitor 215) are attributed to a particular marketing campaign by a marketing-campaign attributer 250. For example, the marketing-campaign attributer 250 may receive information about an accessed landing page 104a (e.g., its URL and the date and time of access) from the landing-page-access monitor 215. The marketing-campaign attributer 250 may forward part or all of this information to the landing-page associator 210, which may respond to the marketing-campaign attributer 250 with an identity of the marketing campaign associated with the landing page 104a (e.g., based on an analysis of the landing-page associations 108). The marketing-campaign attributer 250 may determine whether the marketing campaign identified should be credited with particular accesses to and/or interactions with the web site 104. For example, the marketing-campaign attributer 250 may determine whether a visitor accessed any other landing pages 104a associated with other marketing campaigns between his access to the landing page 104a associated with the identified marketing campaign and an increased progression level. The marketing-campaign attributer 250 may store associations between specific marketing campaigns and interaction variables (e.g., increased progression levels and a date and time of the increase).

The campaign statistics generator 124 may be coupled to the landing-page-access monitor 215, the interaction analyzer 235 and/or the marketing-campaign attributer 250. Thus, for example, the campaign statistics generator 124 may receive data identifying a when visitors' accessed particular landing pages, when and how visitors' interacted with the web site (e.g., subsequent to access to the landing page), and marketing campaigns credited with these actions. As described further herein, campaign statistics generator 124 may then generate and/or update campaign statistics 128 in view of this data.

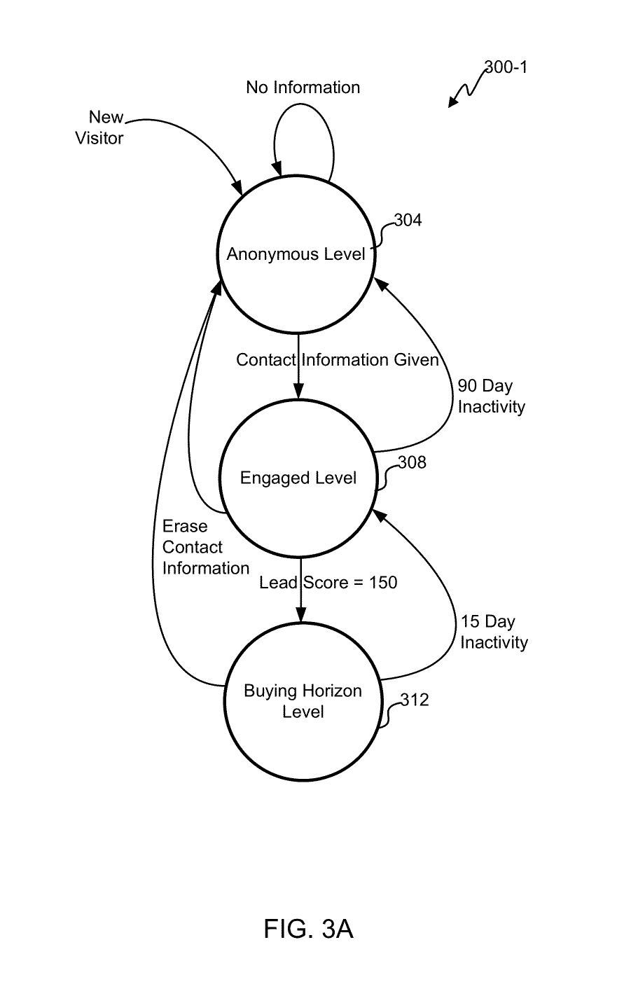

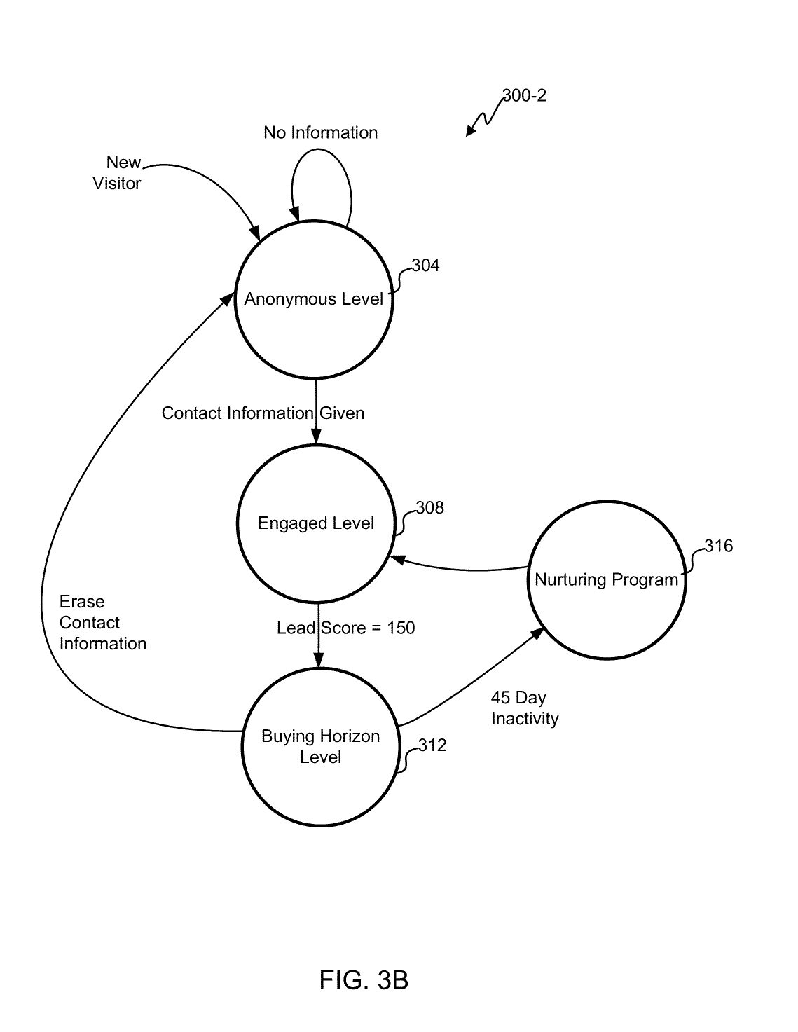

With reference to FIG. 3A, a level diagram of an embodiment of a progression level design 300-1 is shown. The progression level design 300-1 is stored in as a progression design 120 and can be for a single web site 104 or a group of web sites. This embodiment includes three levels, but there could be any number of levels as defined by a customer. This embodiment includes an anonymous level 304 where visitors 132 first land on the web site 104 without giving any information. Once information is given by the visitor or the marketing automation system 112, the visitor progresses to an engaged level 308.

For each visitor 132 that is identified, a lead score is tracked. The lead score can be a function of the amount of interaction where different actions are given different scores. For example, downloading a white paper, providing additional demographic information, answering questions, viewing video or audio content, reading web pages, browsing time, or other behavioral information is scored to change the lead score. Additionally, the demographic or other information provided to the web site 104 can affect the lead score. For example, a purchasing manager title given may be scored higher than the title of janitor. Once a threshold lead score is reached, the visitor moves to a buying horizon level 312.

Reports of stagnant visitors are generated so that remedial action can be manually or automatically taken. For example, a visitor might be moved from a later-stage level to an earlier-stage level where there has been a period of inactivity. This keeps the highly-qualified leads in the later-stage levels to a minimum to reduce the visitors that are unlikely to be customers. In this embodiment, stagnant visitors are automatically moved from the buying horizon level 312 to the engaged level 308 after a period (e.g., 15 days) of inactivity and from the engaged level 308 to the anonymous level 304 a period (e.g., 90 days) of inactivity. Additionally, a visitor 132 in this embodiment moves back to the anonymous level 304 where the visitor 132 manually erases contact information previously given to the web site 104.

Referring next to FIG. 3B, a level diagram of an embodiment of a progression level design 300-2 is shown. This embodiment adds an additional level over the embodiment of FIG. 3A. The number of levels and conditions that move between levels is unlimited and only bounded by the complexity desired by the customer. When in the buying horizon level 312 and there has been 45 days without interaction with the web site 104 by the visitor, the visitor is moved to a nurturing program level 316. Any number of things could be done in this level to make the web site 104 or customer more inviting to the visitor before returning to the engaged level 308. For example, advertizing could be removed from the web site 104, coupons could be offered, personalization of the web site 104 for the visitor could be performed, representatives of the web site could call, text or e-mail the visitor, etc.

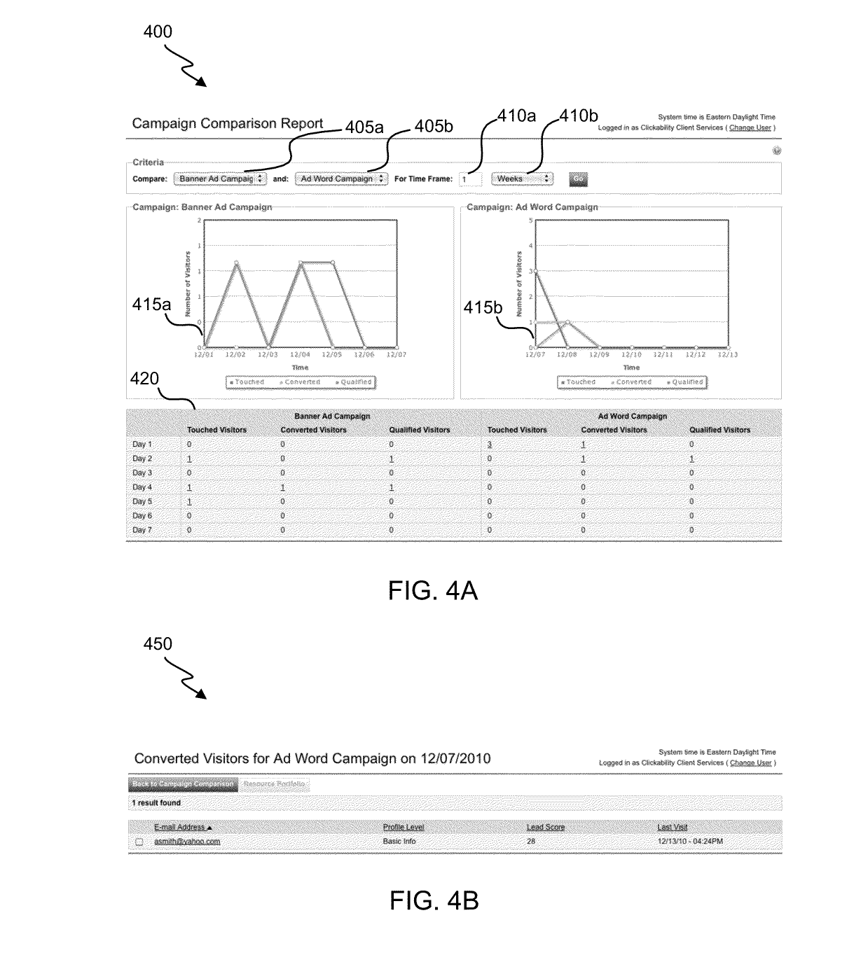

With reference to FIG. 4A, an embodiment a report 400 presenting statistics for two marketing campaigns is presented. As shown, the report 400 allows a customer viewing the report to see a numbers of visitors associated with each of two selected campaigns. Specifically, two campaign-selection controls 405a and 405b are presented, which may include pull-down controls. A customer selects a marketing campaign (e.g., using one campaign-selection control 405). Campaign-selection options (e.g., shown when a customer clicks on a pull-down control) may include one, more or all campaigns associated with a unique landing page tied to a particular web site (e.g., the customer's web site).

The ease in which different landing pages may be tied to different campaign characteristics allows a customer to compare many campaign strategies and identify a near-optimal or optimal marketing technique. For example, a customer may have the capability of comparing different campaign strategies (e.g., e-mail campaigns versus search-engine advertisement campaigns), different campaign time periods (e.g., a month of delivery of e-mail campaigns), campaigns managed by different third parties (e.g., associated with different search engines), etc.: the customer could merely create a new landing page for each different campaign and/or campaign characteristic. In some instances, a customer may select a campaign meeting a particular criteria rather than a particular campaign (e.g., “Longest-operating campaign”; “Campaign Leading to Most Touches”; “Campaign Leading to Fewest Conversions”; etc.).

A customer may identify a time frame of interest to view campaigns' results. For example, a customer may enter a value 410a and unit 410b of a time frame for the report 400. In FIG. 4A, a time frame of one week is examined. The time frame may extend from a campaign's start date and/or from a date that a landing page was published and/or identified as being tied to an operational campaign. Thus, in FIG. 4A, the time frames associated with the Banner Ad Campaign and the Ad Word Campaign are the same duration but correspond to different dates (e.g., because the campaigns started on different dates). In some embodiments, a customer may be able to select one or more dates of interest (e.g., identifying a start date and an end date or a start date and a time frame).

Upon a customer's confirmation of selections of the campaigns and time frame, a report may be automatically generated. The report may include one or more graphs, one or more tables, one or more illustrations, and/or text. The report may identify campaign statistics, e.g., related to visitors the accessed a landing page associated with the campaign, their interactions with the web site, their progression level, and/or their change in progression levels.

For example, one or more campaign-statistics graphs 415a and 415b and/or one or more campaign-statistics tables 420 may be generated and displayed. The graphs 415a and 415b and/or table(s) 420 may identify a number of visitors associated with a selected marketing campaign. The graphs 415a and 415b and/or table(s) 420 may include a number of touched visitors (who accessed a landing page), a number of converted visitors (converted from an anonymous level to an engaged level based on information provided by the visitor), and/or a number of qualified visitors (having reached a buying-horizon progression level). Additional information that may be presented could identify, e.g., visitors' current progression level, visitors' movement in progression level (e.g., movement attributed to a campaign or subsequent movement, e.g., related to inactivity), etc. Presented information may be totaled across the entire selected time frame (e.g., identifying a number of visitors who touched the landing page across the total time frame) or may be discretized into finer time increments (e.g., as in graphs 415a and 415b and in table 420). Using similar or the same time frames and/or time discretization for each presented marketing campaign may assist a customer in comparing the campaigns.

The report 400 thus allows a customer to view a side-by-side comparison of two campaigns. In some instances, graphs and/or statistics may be presented which further emphasize similarities and/or distinctions between campaigns. For example, a graph may be presented that plots results attributed each campaign (e.g., a “touched” graph may be created and different line colors may be used for each campaign, or a bar graph may be created with x-values corresponding to “touched”, “converted” and “qualified” and each campaign being identified by a different set of colored bars). Statistics may identify, e.g., a ratio of visitors or a type of visitor (e.g., “converted”) resulting from a first selected campaign as compared to a second selected campaign.

The depicted report 400 allows for a customer to view absolute results associated with one or two campaigns. Another type of report 400 may allow a customer to identify contributions of a given campaign to total visitor-related results. For example, a report may identify and weight campaigns that were credited with all visitors that touched a web site during a time frame, or all visitors that were converted or qualified during a time frame. For example, a pie graph or stacked bar graph may be presented, thereby visually associating a plurality of campaigns with their credited contribution to visitors' interactions with the web site.

With reference to FIG. 4B, an embodiment a detailed report 450 for presenting details about visitors associated with a marketing campaign is presented. A customer may be able to interact with the generated report 400 and thereby view additional information about visitors. For example, a customer may be able to select (e.g., click on) the “1” located in the “Day 1” row and “Ad Word Campaign: Converted Visitors” column in table 420 of the report 400. A detailed report 450 may then be generated and displayed, which presents additional details about the 1 visitor who was converted on Day 1, the conversion being associated with the Ad Word Campaign. The additional details may include, e.g., identifying information (e.g., an e-mail address), profile level, lead score, and one or more times associated with visits to the web site. Additional information (e.g., time of first visit, time of access to a landing campaign associated with the campaign, conversion time, web-site interaction, visitor profile details, etc.) may further be provided.

A customer may be able to request and receive report 400 and/or detailed report 450 via a web browser and/or software. For example, the customer may log into an account (e.g., a same account used to create landing pages and associate landing pages with marketing campaigns), select an online campaign-report option, use web-browser features to make and confirm selections indicating desired report characteristics, and view and/or interact with generated reports via the web browser. Requests for reports or data used for report generation may be sent from a local device to a remote server. The report may be generated locally on a customer device (e.g., via installed software) or remotely.

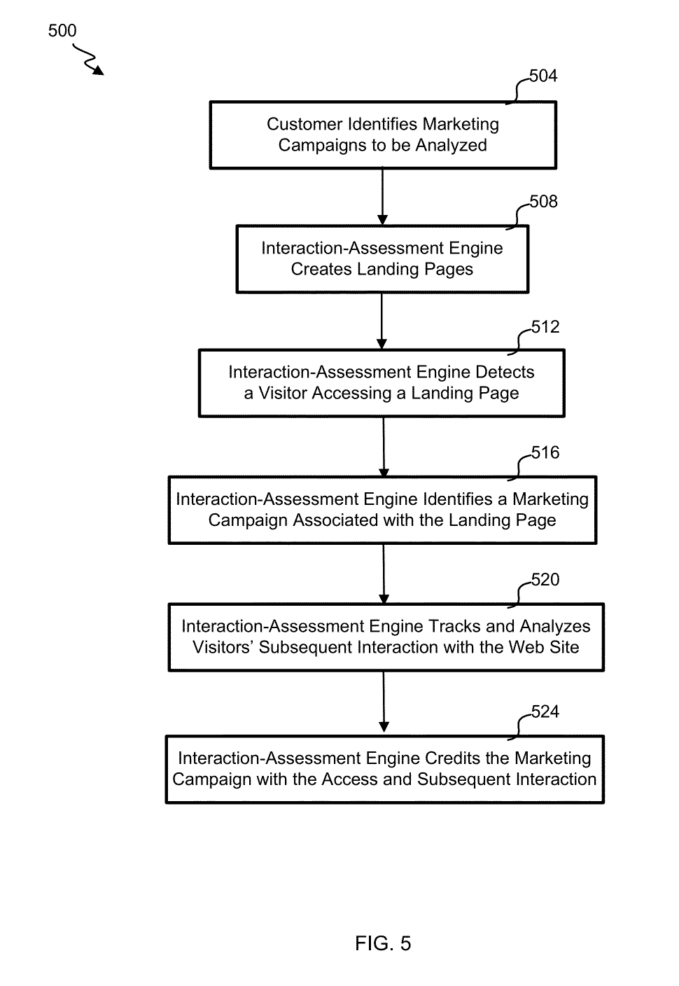

With reference to FIG. 5, a flowchart of an embodiment of a process 500 for analyzing marketing campaigns is shown. The depicted portion of the process 500 begins in block 504 where a customer identifies marketing campaigns to be analyzed. A landing page 104a is created for each of the identified marketing campaigns by interaction-assessment engine 112 in block 508. Each landing page 104a may be associated with a unique URL and may or may not have different content as compared to other landing pages 104a. Each landing page 104a is a part of, and/or linked to other web pages on, a web site 104 of the customer.

The interaction-assessment engine 112 monitors each landing page 104a, and in block 512, detects a visitor accessing one landing page 104a. The marketing campaign associated with the accessed landing page 104a is identified in block 516. For example, the interaction-assessment engine may consult a look-up table listing URLs of landing pages and associated marketing campaigns.

Visitors' interactions with the web site 104 subsequent to the landing-page access are tracked and analyzed in block 520. For example, factors such as total time spent on the web site 104, responsiveness to queries, and entered demographical information may be analyzed to identify a lead score. The lead score may be used to determine a progression level.

The interaction-assessment engine credits the marketing campaign associated with the landing page with the access and/or subsequent interaction in block 524. For example, the marketing campaign may be credited with increases in visitors' progression level. In some instances, a visitor may have accessed multiple landing sites. A crediting-selection algorithm may be used to determine how to allocate credit for the visitor's access to and/or interaction with the web site. For example, credit may be given to the marketing campaign associated with the landing page accessed most recently prior to an interaction (e.g., resulting in a progression-level increase).

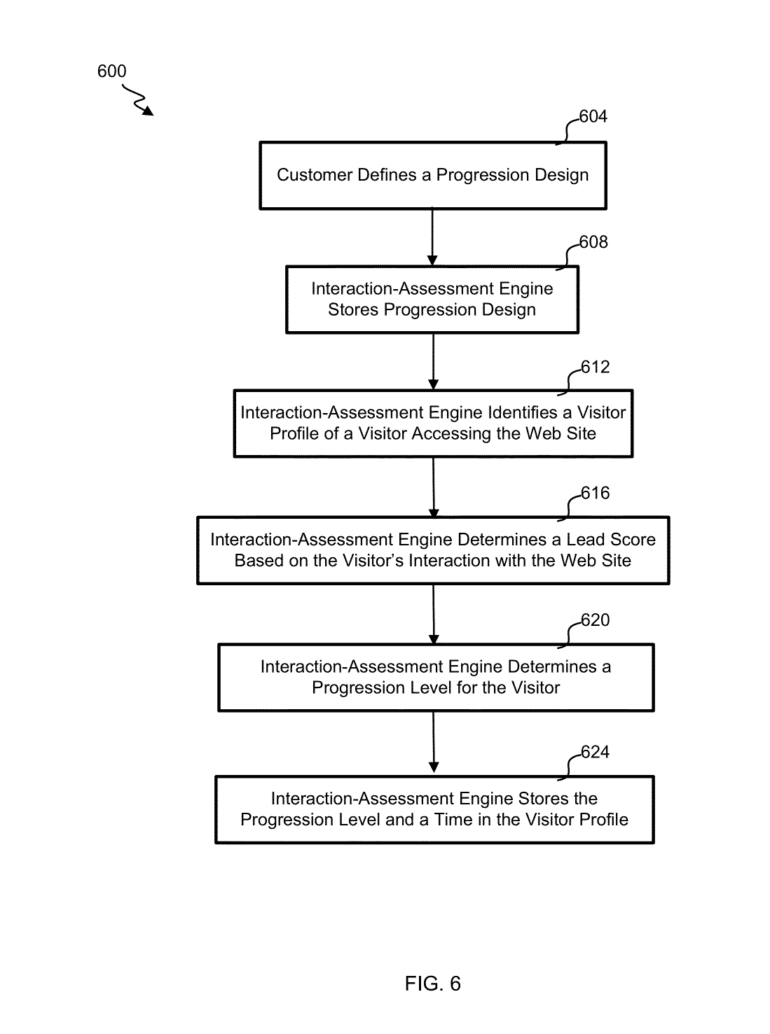

With reference to FIG. 6, a flowchart of an embodiment of a process 600 for analyzing visitors' interactions with a web site is shown. The depicted portion of the process 600 begins in block 604 where a customer creates a progression design 120, which includes progression levels and conditions for moving between those levels. The progression level design is stored by the interaction-assessment engine 112 as a progression design 120 in block 508.

Following a detection that a visitor 132 is accessing the web site 104, the interaction-assessment engine 112 identifies a visitor profile 116 of the visitor 132. For example, profiles may be searched for a unique identifier, a cookie, etc. received from a device of the visitor 132. As another example, profiles may be searched for a URL and/or portion of a URL of a landing page 104a suggestive of an identity of the visitor 132. If no profile 116 is identified, a new profile 116 may be created and/or a default (e.g., blank) profile may be used.

Based on a visitor's interaction with the web site 104, a lead score is determined by the interaction-assessment engine 112 in block 616. Determination of the lead score may include generating a new lead score or updating a lead score (e.g., stored in the identified visitor profile 116) based on recent interactions (e.g., following and/or including access to a landing page).

A progression level for the visitor is determined by the interaction-assessment engine in block 620. The determination may include determining a new progression level or updating a progression level (e.g., stored in the identified visitor profile 116). The determination may include comparing the lead score to one or more thresholds. The determined progression level and a time are stored in the visitor profile 116 in block 624. The time may be the time at which the progression level was determined (or updated) and/or a time of particular events or interactions that contributed to the determination (e.g., times of recent interactions with the web site 104).

As described else wherein, interactions and web-site access may be associated with and/or attributed to particular marketing campaigns. These associations and/or attributions may further be stored in the visitor profile. Thus, e.g., the campaign statistics generator 124 may receive data directly from the interaction-assessment engine 112 and/or from visitor profiles 116 to generate and/or update campaign statistics 128.

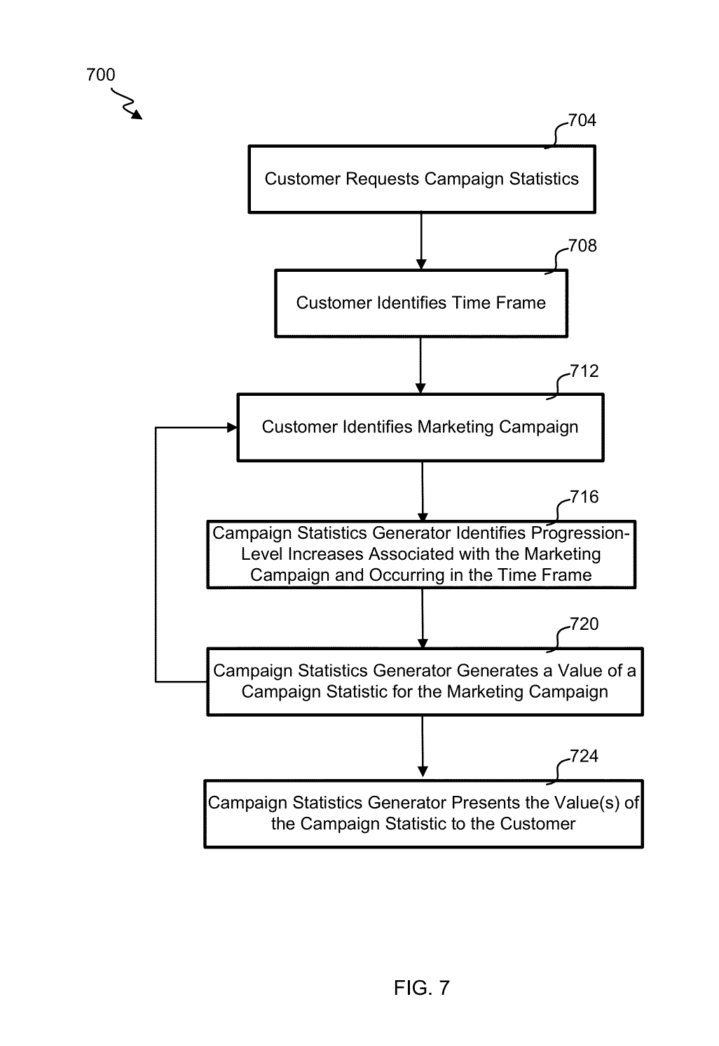

With reference to FIG. 7, a flowchart of an embodiment of a process 700 for generating campaign statistics is shown. The depicted portion of the process 700 begins in block 704 where a customer requests campaign statistics. For example, a customer may access a statistics-related web page or may select an option provided by campaign-analysis software. The request may include a general request (e.g., “Generate Statistics”) or a request as to one or more particular types of statistics of interest.

The customer identifies a time frame for analysis in block 708. The time frame may include a duration and/or specific dates. The customer identifies a marketing campaign in block 712. The marketing campaign may be selected from amongst a variety of marketing campaigns (e.g., each associated with a landing page of a web site).

The campaign statistics generator 124 identifies data associated with the marketing campaign and the time frame in block 716. Specifically, the campaign statistics generator 124 identifies any progression-level increases attributed to the marketing campaign and having occurred (or being based on events or interactions that occurred) during the time frame. The campaign statistics generator 124 may identify this data by, e.g., searching visitor profiles 116 for dates and times and progression-level increases and marketing campaigns associated with the increases.

Based on the identified data, the campaign statistics generator 124 generates a value of a campaign statistic 128 for the marketing campaign in block 720. For example, the campaign statistics generator 124 may identify a number of visitors that progressed from Progression Level 1 (e.g., “Anonymous”) to Progression Level 2 (e.g., “Converted”), a number of visitors that progressed at least one level, a total number of level progressions, etc. Blocks 712-720 may be repeated for one or more marketing campaigns. The values of the campaign statistic 128 associated with each identified marketing campaign are presented to the customer in block 724. For example, the values may be presented in a report 400. The report 400 could be displayed, printed or sent in electronic form to the customer. An interface to the campaign-analysis system 100 allows for interaction with the report 400. The presentation may allow the customer to compare multiple campaigns (e.g., by comparing side-by-side values of the statistics).

A number of variations and modifications of the disclosed embodiments can also be used. For example, analysis of marketing campaigns promoting visitor interactions with a web site is described, but similar analysis may be performed of marketing campaigns promoting visitor interactions with, e.g., application software, a run-time applet, a smart-phone application, or any software function that provide information to potential customers.

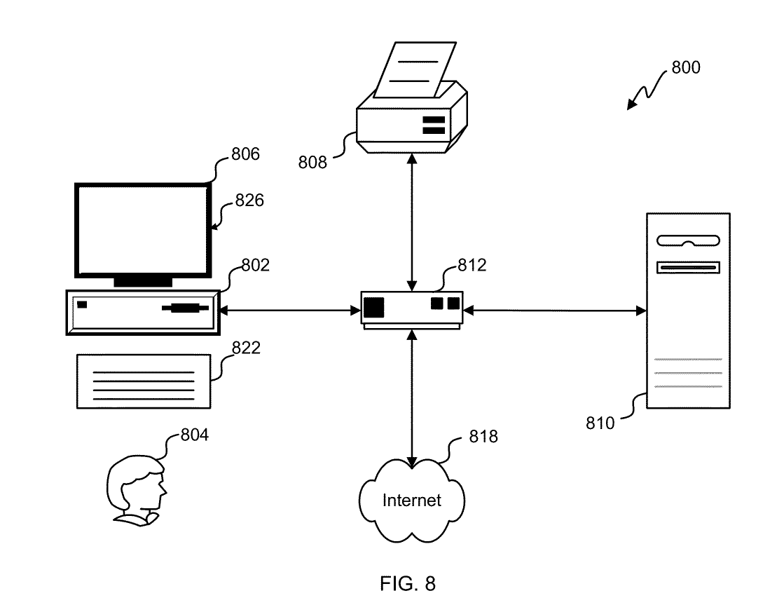

Referring next to FIG. 8, an exemplary environment with which embodiments may be implemented is shown with a computer system 800 that can be used by a designer 804 to design, for example, electronic designs. The computer system 800 can include a computer 802, keyboard 822, a network router 812, a printer 808, and a monitor 806. The monitor 806, processor 802 and keyboard 822 are part of a computer system 826, which can be a laptop computer, desktop computer, handheld computer, mainframe computer, etc. The monitor 806 can be a CRT, flat screen, etc.

A designer 804 can input commands into the computer 802 using various input devices, such as a mouse, keyboard 822, track ball, touch screen, etc. If the computer system 800 comprises a mainframe, a designer 804 can access the computer 802 using, for example, a terminal or terminal interface. Additionally, the computer system 826 may be connected to a printer 808 and a server 810 using a network router 812, which may connect to the Internet 818 or a WAN.

The server 810 may, for example, be used to store additional software programs and data. In one embodiment, software implementing the systems and methods described herein can be stored on a storage medium in the server 810. Thus, the software can be run from the storage medium in the server 810. In another embodiment, software implementing the systems and methods described herein can be stored on a storage medium in the computer 802. Thus, the software can be run from the storage medium in the computer system 826. Therefore, in this embodiment, the software can be used whether or not computer 802 is connected to network router 812. Printer 808 may be connected directly to computer 802, in which case, the computer system 826 can print whether or not it is connected to network router 812.

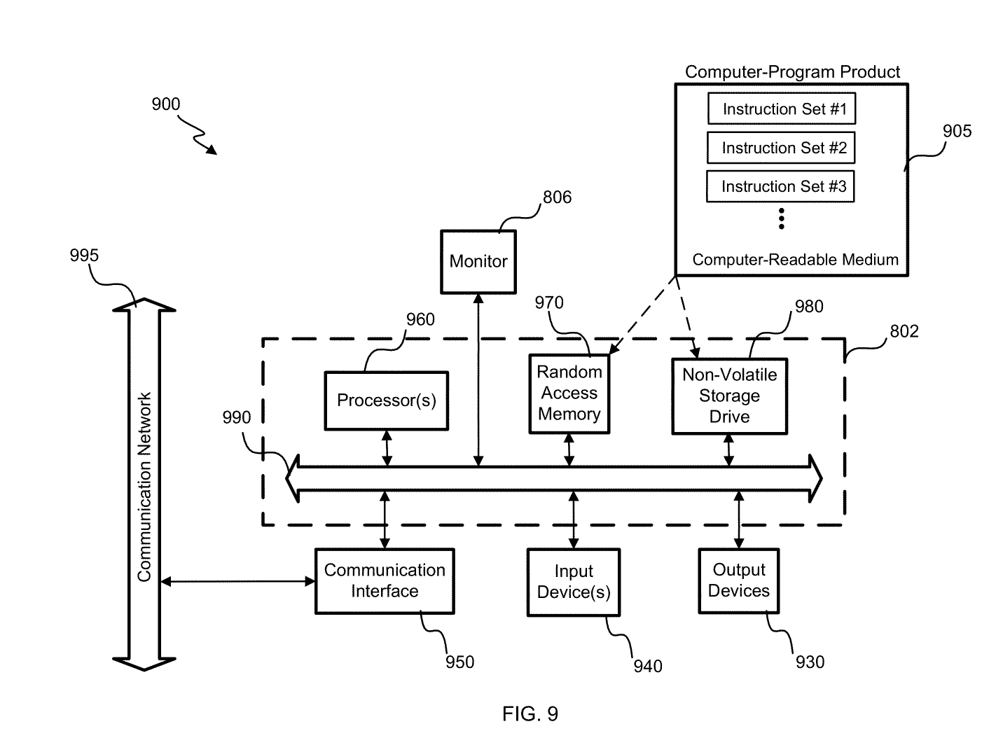

With reference to FIG. 9, an embodiment of a special-purpose computer system 900 is shown. The interaction-assessment engine 112, campaign-statistics generator 124, and marketing automation system 154 are examples of a special-purpose computer system 900. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 826, it is transformed into the special-purpose computer system 900.

Special-purpose computer system 900 comprises a computer 802, a monitor 806 coupled to computer 802, one or more additional user output devices 930 (optional) coupled to computer 802, one or more user input devices 940 (e.g., keyboard, mouse, track ball, touch screen) coupled to computer 802, an optional communications interface 950 coupled to computer 802, a computer-program product 905 stored in a tangible computer-readable memory in computer 802. Computer-program product 905 directs system 900 to perform the above-described methods. Computer 802 may include one or more processors 960 that communicate with a number of peripheral devices via a bus subsystem 990. These peripheral devices may include user output device(s) 930, user input device(s) 940, communications interface 950, and a storage subsystem, such as random access memory (RAM) 970 and non-volatile storage drive 980 (e.g., disk drive, optical drive, solid state drive), which are forms of tangible computer-readable memory.

Computer-program product 905 may be stored in non-volatile storage drive 980 or another computer-readable medium accessible to computer 802 and loaded into memory 970. Each processor 960 may comprise a microprocessor, such as a microprocessor from Intel® or Advanced Micro Devices, Inc.®, or the like. To support computer-program product 905, the computer 802 runs an operating system that handles the communications of product 905 with the above-noted components, as well as the communications between the above-noted components in support of the computer-program product 905. Exemplary operating systems include Windows® or the like from Microsoft Corporation, Solaris® from Sun Microsystems, LINUX, UNIX, and the like.

User input devices 940 include all possible types of devices and mechanisms to input information to computer system 802. These may include a keyboard, a keypad, a mouse, a scanner, a digital drawing pad, a touch screen incorporated into the display, audio input devices such as voice recognition systems, microphones, and other types of input devices. In various embodiments, user input devices 940 are typically embodied as a computer mouse, a trackball, a track pad, a joystick, wireless remote, a drawing tablet, a voice command system. User input devices 940 typically allow a user to select objects, icons, text and the like that appear on the monitor 806 via a command such as a click of a button or the like. User output devices 930 include all possible types of devices and mechanisms to output information from computer 802. These may include a display (e.g., monitor 806), printers, non-visual displays such as audio output devices, etc.

Communications interface 950 provides an interface to other communication networks and devices and may serve as an interface to receive data from and transmit data to other systems, WANs and/or the Internet 818. Embodiments of communications interface 950 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 950 may be coupled to a computer network, to a FireWire® bus, or the like. In other embodiments, communications interface 950 may be physically integrated on the motherboard of computer 802, and/or may be a software program, or the like.

RAM 970 and non-volatile storage drive 980 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 970 and non-volatile storage drive 980 may be configured to store the basic programming and data constructs that provide the functionality of various embodiments of the present invention, as described above.

Software instruction sets that provide the functionality of the present invention may be stored in RAM 970 and non-volatile storage drive 980. These instruction sets or code may be executed by the processor(s) 960. RAM 970 and non-volatile storage drive 980 may also provide a repository to store data and data structures used in accordance with the present invention. RAM 970 and non-volatile storage drive 980 may include a number of memories including a main random access memory (RAM) to store of instructions and data during program execution and a read-only memory (ROM) in which fixed instructions are stored. RAM 970 and non-volatile storage drive 980 may include a file storage subsystem providing persistent (non-volatile) storage of program and/or data files. RAM 970 and non-volatile storage drive 980 may also include removable storage systems, such as removable flash memory.

Bus subsystem 990 provides a mechanism to allow the various components and subsystems of computer 802 communicate with each other as intended. Although bus subsystem 990 is shown schematically as a single bus, alternative embodiments of the bus subsystem may utilize multiple busses or communication paths within the computer 802.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

1. A program-analysis system for quantitatively estimating increases in web-site communications attributed to various recruitment programs, the program-analysis system comprising:
a plurality of landing pages, each landing page of the plurality of landing pages comprising a unique landing-page uniform resource locator (URL), and each landing page of the plurality of landing pages allowing a visitor to access the web site;
a computer-stored landing-page database storing associations between each of the plurality of landing pages with a recruitment program, the recruitment programs comprising e-mail campaigns in which a link-embedded message is emailed to visitor prospects;
a computer-stored visitor-profile database storing a visitor profile for each of a plurality of visitors, each visitor profile comprising historical-interaction information characterizing any previous interaction between the visitor and the web site, each visitor profile further comprising an email address of an associated visitor;
an interaction-assessment engine, comprising a processor, configured to, for each visitor of a plurality of visitors that accesses each landing page of the plurality of landing pages:
detect the visitor's access to a landing page;
identify a recruitment program associated with the landing page based on an analysis of a URL of the landing page;
associate the visitor with a visitor profile stored in the visitor-profile database;
track the visitor's interaction with the web site subsequent to the visitor's access to the landing page;
update the visitor's profile to include the tracked interaction;
determine recent-interaction information characterizing the visitor's interaction with the web site subsequent to the visitor's access to the landing page;
identify a change between the historical-interaction information and the recent-interaction information in the profile; and
attribute the recruitment program associated with the landing page with the change between the historical-interaction information and the recent-interaction information in the profile; and
a statistics generator configured to generate or update a value of at least one statistical variable associated with the recruitment program, the value of the at least one statistical variable being related to an efficacy of the recruitment program at increasing visitors' communication with the web site, and the generation or updating being based on any changes between the historical-interaction information and the recent-interaction information attributed to the recruitment program.

2. The program-analysis system for quantitatively estimating increases in web-site communications attributed to various recruitment programs as recited in claim 1, the campaign-analysis system further comprising:
a progression design comprising a plurality of progression levels, the plurality of progression levels comprising a first progression level and a second progression level,
wherein the change between the historical-interaction information and the recent-interaction information in the profile that is identified by the interaction-assessment engine comprises a change from the first progression level to the second progression level.

3. The program-analysis system for quantitatively estimating increases in web-site communications attributed to various recruitment programs as recited in claim 1, wherein the statistics generator is further configured to generate a report presenting the value of the at least one statistical variable associated with the recruitment program and presenting a second value of the at least one statistical variable associated with a second recruitment program.

4. The program-analysis system for quantitatively estimating increases in web-site communications attributed to various recruitment programs as recited in claim 1, wherein the statistics generator is further configured to:
receive input comprising an analysis time frame; and
generate or update the value of the at least one statistical variable based on any changes between visitors' historical interaction information and visitors' recent interaction information attributed to the recruitment program, the changes occurring within the analysis time frame.

5. The program-analysis system for quantitatively estimating increases in web-site communications attributed to various recruitment programs as recited in claim 1, wherein the at least one statistical variable comprises a number of visitors that accessed a landing page associated with the recruitment program.

6. The program-analysis system for quantitatively estimating increases in web-site communications attributed to various recruitment programs as recited in claim 1, wherein the at least one statistical variable comprises a number of visitors that interacted with the web site subsequent to the visitors' access to the landing page, the interaction comprising entering identifying information via the web site.

7. The program-analysis system for quantitatively estimating increases in web-site communications attributed to various recruitment programs as recited in claim 1, wherein the interaction-assessment engine is further configured to, for each visitor of the plurality of visitors that accesses each landing page of the plurality of landing pages:
determine whether the visitor can be partly or completely identified,
wherein the visitor is associated with a default visitor profile stored in the visitor-profile database upon a determination that the visitor cannot be partly or completely identified.

8. A computer-implemented method for quantitatively estimating increases in web-site communications attributed to various recruitment programs, the method comprising:
using a server computer to create a plurality of landing pages for a web site, each landing page of the plurality of landing pages comprising a unique landing-page uniform resource locator (URL), and each landing page of the plurality of landing pages allowing a visitor to access the web site;
associating each of the plurality of landing pages with a recruitment program of a plurality of recruitment programs, the recruitment programs comprising e-mail campaigns in which a link-embedded message is emailed to visitor prospects;
monitoring visitors' access to each of the plurality of landing pages;
upon detecting a visitor accessing a landing page of the plurality of landing pages:
identifying a recruitment program of the plurality of recruitment programs associated with the landing page based on an analysis of a URL of the landing page;
associating the visitor with a visitor profile, the visitor profile comprising an email address of the associated visitor;
tracking the visitor's communications with the web site subsequent to the visitor's access to the landing page; and
updating the profile of the visitor to include the tracked interaction;
generating a value of a statistical variable, the value of the statistical variable being related to an efficacy of the recruitment program identified by the input at increasing visitors' communications with the web site; and
presenting value of the statistical variable to the user.

9. (canceled)

10. The method for quantitatively estimating increases in web-site communications attributed to various recruitment programs as recited in claim 8, the method further comprising:
upon the detecting the visitor accessing the landing page of the plurality of landing pages:
updating, based on the visitor's communications with the web site subsequent to the visitor's access to the landing page, a progression level associated with the visitor.

11. The method for quantitatively estimating increases in web-site communications attributed to various recruitment programs as recited in claim 10, wherein the value of the statistical variable identifies a number of visitors that increased progression levels.

12. The method for quantitatively estimating increases in web-site communications attributed to various recruitment programs as recited in claim 8, the method further comprising:
receiving second input from a user, the second input identifying a second recruitment program of the plurality of recruitment programs;
generating a second value of the statistical variable, the second value being related to an efficacy of the second recruitment program identified by the second input at increasing visitors' communications with the web site; and
presenting the second value of the statistical variable to the user,
wherein the value and second value of the statistical variable are presented to the user simultaneously.

13. The method for quantitatively estimating increases in web-site communications attributed to various recruitment programs as recited in claim 12, wherein the value and the second value of the statistical variable are presented graphically to the user.

14. The method for quantitatively estimating increases in web-site communications attributed to various recruitment programs as recited in claim 8, wherein the value of the statistical variable identifies a number of visitors that accessed a landing page, the landing page being associated with the recruitment program identified by the input.

15. One or more non-transitory machine-readable medium having machine-executable instructions configured to quantitatively estimate increases in web-site communications attributed to various recruitment programs, the one or more machine-readable medium comprising code for:
creating a plurality of landing pages for a web site, each landing page of the plurality of landing pages comprising a unique landing-page uniform resource locator (URL), and each landing page of the plurality of landing pages allowing a visitor to access the web site;
associating each of the plurality of landing pages with a recruitment program of a plurality of recruitment programs, the recruitment programs comprising e-mail campaigns in which a link-embedded message is emailed to visitor prospects;
monitoring visitors' access to each of the plurality of landing pages;
upon detecting a visitor accessing a landing page of the plurality of landing pages:
identifying a recruitment program of the plurality of recruitment programs associated with the landing page based on an analysis of a URL of the landing page;
associating the visitor with a visitor profile, the visitor profile comprising an email address of the associated visitor;
tracking the visitor's communications with the web site subsequent to the visitor's access to the landing page; and
updating the profile of the visitor to include the tracked interaction;
generating a value of a statistical variable, the value being related to an efficacy of the recruitment program identified by the input at increasing visitors' communications with the web site; and
presenting the value of the statistical variable to the user.

16. One or more non-transitory machine-readable medium having machine-executable instructions configured to quantitatively estimate increases in web-site communications attributed to various recruitment programs as recited in claim 15, wherein the statistical variable identifies a number of visitors that increased progression levels.

17. One or more non-transitory machine-readable medium having machine-executable instructions configured to quantitatively estimate increases in web-site communications attributed to various recruitment programs as recited in claim 15, wherein the statistical variable identifies a number of visitors that accessed a landing page associated with the recruitment program identified by the input.

18. One or more non-transitory machine-readable medium having machine-executable instructions configured to quantitatively estimate increases in web-site communications attributed to various recruitment programs as recited in claim 15, wherein the value of the statistical variable is presented graphically in a report.

19. One or more non-transitory machine-readable medium having machine-executable instructions configured to quantitatively estimate increases in web-site communications attributed to various recruitment programs as recited in claim 15, the one or more machine-readable medium further comprising code for:
receiving second input from a user, the second input identifying a second recruitment program of the plurality of recruitment programs;
generating a second value of the statistical variable, the second value being related to an efficacy of the second recruitment program identified by the second input at increasing visitors' communications with the web site; and
presenting the second value of the statistical variable to the user,
wherein the value and the second value of the statistical variable are presented to the user simultaneously.

20. One or more non-transitory machine-readable medium having machine-executable instructions configured to quantitatively estimate increases in web-site communications attributed to various recruitment programs as recited in claim 15, the one or more machine-readable medium further comprising code for:
receiving time-frame input from a user identifying a time frame,
wherein the value of the statistical variable is related to an efficacy of the recruitment program identified by the input at increasing visitors' communications with the web site during the identified time frame.
